(19) United States
(12) Patent Application Publication
(10) Pub. No.: US 2025/0063982 A1
(43) Pub. Date: Feb. 27, 2025

(54) OUTDOOR POWER EQUIPMENT WITH UNEQUAL BLADE RPM CONTROL

(71) Applicant: HUSQVARNA AB, Huskvarna (SE)

(72) Inventors: John SOUTHWELL, Huntersville, NC (US); Matthew ALBINGER, Shelby, NC (US)

(21) Appl. No.: 18/726,974

(22) PCT Filed: Jan. 7, 2022
(86) PCT No.: PCT/US2022/011593

§ 371 Date: Jul. 5, 2024

(51) Int. Cl. A01D 34/00; A01D 34/66; A01D 34/685; A01D 34/78; A01D 101/00

(52) U.S. Cl. CPC A01D 34/006; A01D 34/66; A01D 34/685; A01D 34/78; A01D 2101/00

(57) ABSTRACT

A blade speed control module (100) for outdoor power equipment (10) having at least a first cutting blade (130) and a second cutting blade (132) may include processing circuitry (110). The processing circuitry (110) may be configured to receive an operational setting defining a first target blade speed for the first cutting blade (130) and a second target blade speed for the second cutting blade (132), where the first and second cutting blade speeds are different, receive blade speed data indicating a first current blade speed for the first cutting blade (130) and a second current blade speed for the second cutting blade (132), and control blade speeds for each of the first and second cutting blades (130 and 132) to cause the first and second current blade speeds to substantially match the first and second target blade speeds, respectively.

### TECHNICAL FIELD

Example embodiments generally relate to outdoor power equipment and, more particularly, some embodiments relate to a module that can be added to such equipment for monitoring engine revolutions per minute (RPM) and, in some cases, providing the capability to manage different cutting blade speeds simultaneously to improve efficiency.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines and are relatively inexpensive. Meanwhile, at the other end of the spectrum, riding lawn mowers, such as lawn tractors, can be quite large. Riding lawn mowers can sometimes also be configured with various functional accessories (e.g., trailers, tillers and/or the like) in addition to grass cutting components. Riding lawn mowers provide the convenience of a riding vehicle as well as a typically larger cutting deck as compared to a walk-behind model.

The engines used to power the lawn mowers described above, and many other hand-held, walk-behind, or ride-on pieces of outdoor power equipment (e.g., chainsaws, blowers, snow throwers, tillers, edgers, etc.) have commonly been gasoline or petrol engines in the past. However, more recently, there has been a desire and corresponding movement to develop such devices powered by battery.

With battery powered devices, particularly riding lawn mowers, capacity for range or operating time on a single charge is paramount for many users. Thus, ways to improve the efficiency of such lawn mowers of significant interest.

### BRIEF SUMMARY OF SOME EXAMPLES

Some example embodiments may provide such improved efficiency. In this regard, an example embodiment of a lawn care device may be provided. The device may include a power unit to selectively power the device, a first cutting blade, a second cutting blade, and a blade speed control module. The blade speed control module may include processing circuitry that may be configured to receive an operational setting defining a first target blade speed for the first cutting blade and a second target blade speed for the second cutting blade, where the first and second cutting blade speeds are different. The processing circuitry may be further configured to receive blade speed data indicating a first current blade speed for the first cutting blade and a second current blade speed for the second cutting blade, and control blade speeds for each of the first and second cutting blades to cause the first and second current blade speeds to substantially match the first and second target blade speeds, respectively.

In another example embodiment, a blade speed control module for outdoor power equipment having at least a first cutting blade and a second cutting blade may be provided. The blade speed control module may include processing circuitry that may be configured to receive an operational setting defining a first target blade speed for the first cutting blade and a second target blade speed for the second cutting blade, where the first and second cutting blade speeds are different. The processing circuitry may be further configured to receive blade speed data indicating a first current blade speed for the first cutting blade and a second current blade speed for the second cutting blade, and control blade speeds for each of the first and second cutting blades to cause the first and second current blade speeds to substantially match the first and second target blade speeds, respectively.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of the riding lawn care vehicle according to an example embodiment;

FIG. 2 illustrates a functional block diagram of blade speed control module of an example embodiment;

FIG. 3 illustrates a cutting deck having two cutting blades therein according to an example embodiment;

FIG. 4 illustrates a cutting deck having three cutting blades therein according to an example embodiment; and

FIG. 5 illustrates a functional block diagram of a control system including the blade speed control module according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. Additionally, the term “lawn care” is meant to relate to any yard maintenance activity and need not specifically apply to activities directly tied to grass, turf or sod care. As used herein, operable coupling should be understood to relate to direct or indirect connection that, in either case, enables functional interconnection of components that are operably coupled to each other.

When a microprocessor is introduced into a lawn mower, the potential for employing additional functionality into the control and monitoring of various components of the device may be dramatically increased. For example, by providing a microprocessor in communication with a number of components, sensors and/or safety switch inputs, the corresponding inputs (each of which may be associated with respective different parameters of interest) may be monitored to try to determine certain situations for which control, intervention or other functional activity may be desired. One such parameter of interest is blade speed (e.g., in revolutions per minute (RPM). Whereas a typical lawn mower with multiple cutting blades may aim to keep the blade speed of all blades the same, the fact of the matter is that some blades in a multi-blade system are more impactful on performance than others. Thus, the most efficient way of operating the entire cutting assembly may not be to balance blade speeds, but instead to manage an optimal imbalance in blade speeds. Some example embodiments may do just that.

A typical microprocessor-based system relies upon the microprocessor to assess situations and take actions. The ability to use a microprocessor for initiating various actions can often reduce part count and increase functional capabilities at the same time. Thus, there is significant motivation to rely on the microprocessor for as much control as possible. Within this context, the microprocessor is typically programmed to assess various sensor and/or switch positions to determine the status of corresponding components and make decisions regarding whether to initiate any applicable actions. The actions may include, in some cases, shutting down certain components or shutting down the entire device. However, the microprocessor could also be programmed to monitor certain components and provide specific control over the operation (e.g., the operating speed, current or voltage draw, etc.) of such components. Thus, for example, providing RPM readings to a microprocessor (such as an engine control unit (ECU) or vehicle control unit (VCU)) of outdoor power equipment can enable the blade speeds to be managed individually. Although this technology may be particularly useful for improving efficiency on battery powered outdoor power equipment, it should be noted that application (and advantage) is not limited to such contexts. Thus, for example, gasoline or petrol powered devices may also manage blade speeds individually using example embodiments in some cases.

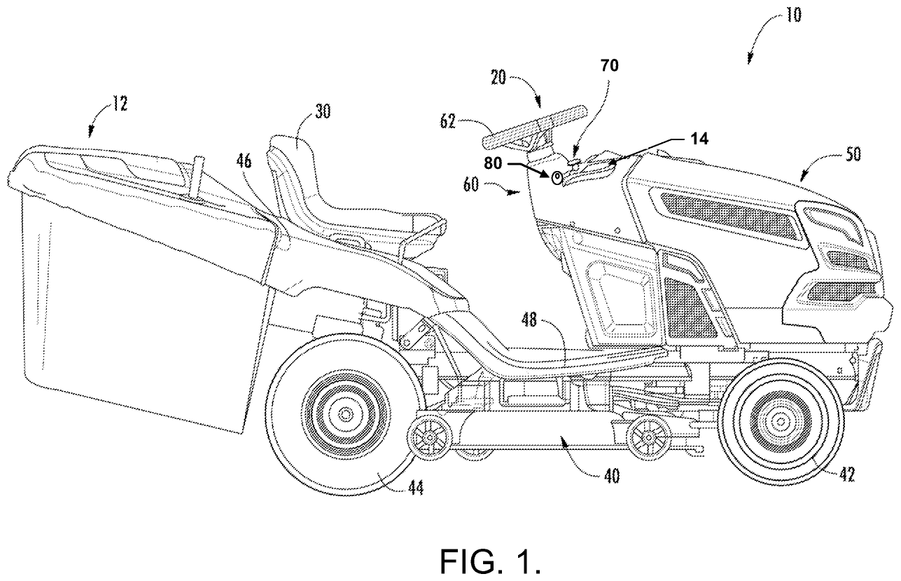

FIG. 1 illustrates an example lawn care device in the form of a riding lawn care vehicle 10 having a bagging attachment 12. However, it should be appreciated that example embodiments may be employed on numerous other riding lawn care vehicles that may not include a bagging attachment 12. The riding lawn care vehicle 10 may include an operations panel 14 that may display operational information regarding the riding lawn care vehicle 10 and host various controls, gauges, switches, lights, displays, and/or the like. As shown and described herein, the riding lawn care vehicle 10 may be a riding lawn mower (e.g., a lawn tractor, front-mount riding lawn mower, riding lawn mower with a zero or near zero degree radius of turn, cross mower, stand-on riding lawn mower, and/or the like). However, example embodiments may also or alternatively be employed on other outdoor power equipment devices, such as walk behind lawn mowers and robotic mowers that employ multiple cutting blades.

The riding lawn care vehicle 10 may include a steering assembly 20 (e.g., including a steering wheel, handle bars, or other steering apparatus) functionally connected to wheels of the riding lawn care vehicle 10 to which steering inputs are provided (e.g., the front and/or rear wheels in various different embodiments) to allow the operator to steer the riding lawn care vehicle 10. In some embodiments, the riding lawn care vehicle 10 may include a seat 30 that may be disposed at a center, rear, or front portion of the riding lawn care vehicle 10. The operator may sit on the seat 30, which may be disposed to the rear of the steering assembly 20 to provide input for steering of the riding lawn care vehicle 10 via the steering assembly 20.

The riding lawn care vehicle 10 may also include, or be configured to support attachment of, a cutting deck 40 having more than one cutting blade mounted therein. In some cases, a height of the at least one cutting blade may be adjustable by an operator of the riding lawn care vehicle 10 (e.g., by adjusting a height of the cutting deck 40). The cutting deck 40 may be a fixed or removable attachment in various different embodiments. Moreover, a location of the cutting deck 40 may vary in various alternative embodiments. For example, in some cases, the cutting deck 40 may be positioned in front of the front wheels 42, behind the rear wheels 44, or in between the front and rear wheels 42 and 44 (as shown in FIG. 1) to enable the operator to cut grass using the at least one cutting blade when the at least one cutting blade is rotated below the cutting deck 40. In some embodiments, the cutting deck 40 may be lifted or rotated relative to the lawn mower frame to permit easier access to the underside of the lawn mower without requiring removal of the cutting deck 40. The cutting deck 40 may have two, three, or more cutting blades driven by one, two, three, or more rotatable shafts. The shafts may be rotated by any number of mechanisms. For example, in some embodiments, the shafts are coupled to a motor via a system of belts and pulleys. In other embodiments, the shafts may be coupled to the motor via a system of universal joints, gears, and/or other shafts. In still other embodiments, such as in an electric lawn mower, the shaft may extend directly from an electric motor positioned over the cutting deck.

In some embodiments, the front wheels 42 and/or the rear wheels 44 may have a shielding device positioned proximate thereto in order to prevent material picked up in the wheels from being ejected toward the operator. Fender 46 is an example of such a shielding device. When operating to cut grass, the grass clippings may be captured by a collection system (e.g., bagging attachment 12), mulched, or expelled from the cutting deck 40 via either a side discharge or a rear discharge.

The riding lawn care vehicle 10 may also include additional control-related components such as one or more speed controllers, brakes, cutting height adjusters, and/or the like. Some of the controllers, such as the speed controllers and/or brakes, may be provided in the form of foot pedals that may sit proximate to a footrest 48 (which may include a portion on both sides of the riding lawn care vehicle 10) to enable the operator to rest his or her feet thereon while seated in the seat 20.

In the pictured example embodiment of FIG. 1, a power unit 50 of the riding lawn care vehicle 10 is disposed substantially forward of a seated operator. However, in other example embodiments, the power unit 50 could be in different positions such as below or behind the operator. In some embodiments, the power unit 50 may be operably coupled to one or more of the wheels of the riding lawn care vehicle 10 in order to provide drive power for the riding lawn care vehicle 10. In some embodiments, the power unit 50 may be capable of powering two wheels, while in others, the power unit 50 may power all four wheels of the riding lawn care vehicle 10. Moreover, in some cases, the power unit 50 may manually or automatically shift between powering either two wheels or all four wheels of the riding lawn care vehicle 10. The power unit 50 may be housed within a cover that forms an power unit compartment to protect components thereof and improve the aesthetic appeal of the riding lawn care vehicle 10. In an example embodiment, the power unit 50 may include a battery and one or more electric motors. However, as noted above, the power unit 50 could be a gasoline or petrol engine in some cases.

In an example embodiment, the power unit compartment may be positioned proximate to and/or mate with portions of a steering assembly housing 60. The steering assembly housing 60 may house components of the steering assembly 20 to protect such components and improve the aesthetic appeal of the riding lawn care vehicle 10. In some embodiments, a steering wheel 62 of the steering assembly 20 may extend from the steering assembly housing 60 and a steering column (not shown) may extend from the steering wheel 62 down through the steering assembly housing 60 to components that translate inputs at the steering wheel 62 to the wheels to which steering inputs are provided.

In some embodiments, the power unit 50 may also provide power to turn the cutting blades disposed within the cutting deck 40. In this regard, for example, the power unit 50 may be used to turn each shaft upon which the cutting blades may be fixed (e.g., directly or via a belt and pulley system and/or other mechanisms). The turning of the shaft, at high speeds, may move the cutting blades through a range of motion that creates air movement that tends to straighten grass for cutting by the moving blade and then eject the cut grass out of the cutting deck 40 (e.g., to the bagging attachment 12 or to the back or side of the riding lawn care vehicle 10), unless the blade and mower are configured for mulching.

In an example embodiment, the power unit 50 may turn at least one shaft that is coupled to corresponding ones of the cutting blades within the cutting deck 40 via a PTO clutch or other electronic controller for controlling powering of the electric motors that turn the blades. When the PTO clutch is engaged, or controller is actuated, rotary power generated by the power unit 50 may be coupled to the cutting blades to cause rotation thereof (e.g., for cutting grass). When the PTO clutch is disengaged, or controller is turned off, rotary power generated by the power unit 50 may not be coupled to the cutting blades and thus the cutting blades may not rotate. In some embodiments, engagement of the PTO clutch or electronic control may be accomplished via operation of a PTO switch or blade actuation switch 70 that may be disposed on or proximate to the operations panel 14.

The operations panel 14, or some other portion of the steering assembly housing 60, may also provide support for an ignition interface or starting assembly 80. The ignition interface or starting assembly 80 may be used for starting the power unit 50 and for controlling other functions of the riding lawn care vehicle 10. In an example embodiment, the ignition interface or starting assembly 80 may or may not require a key to operate. Thus, the operator of the riding lawn care vehicle 10 may be enabled to start and/or initiate one or more functional capabilities of the riding lawn care vehicle 10 either with or without the use of a physical key using the ignition interface or starting assembly 80.

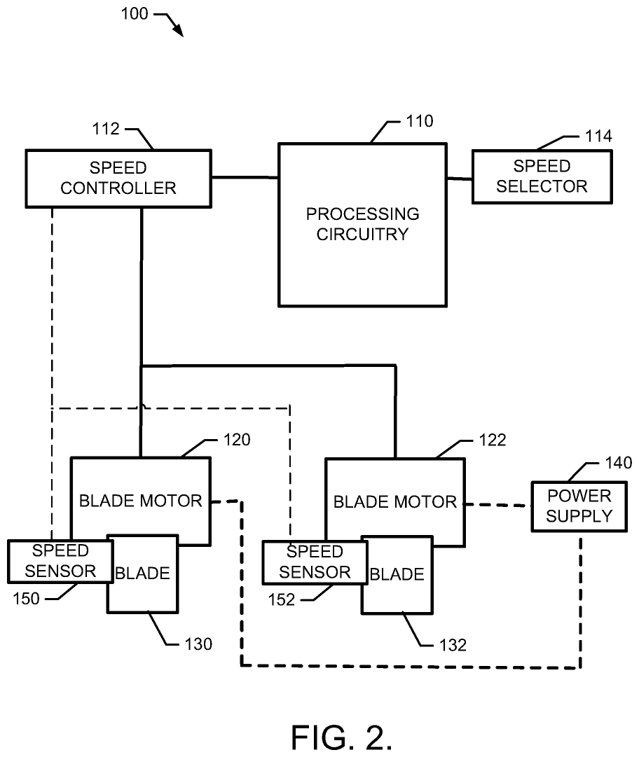

For a relatively robust and sophisticated device like the riding lawn care vehicle 10 of FIG. 1, it may be expected that the electronics onboard can either include, or be adapted to include blade speed monitoring and control (for the engine (if employed) and/or for the cutting blades). Moreover, a specific example blade speed control module for doing so will be discussed by way of non-limiting example in greater detail below in reference to FIG. 2. However, as noted above, it may be possible to employ blade speed monitoring and control on smaller and less sophisticated units as well. Example embodiments may provide an blade speed control module that can be added to engine systems of almost any size to augment or add an blade speed monitoring (and controlling) capability to such engine systems. Thus, FIG. 2 is provided as a high level, and generic example of a blade speed control module 100 in accordance with an example embodiment.

In this regard, FIG. 2 illustrates a functional block diagram of the blade speed control module 100 of an example embodiment. As shown in FIG. 2, the blade speed control module 100 may include processing circuitry 110 (which may include a processor and memory) operably coupled to a speed controller 112 and, in some cases, a speed selector 114. The processing circuitry 110 may control operation of the speed controller 112 automatically (e.g., based on programming or mode selection) and/or in response to speed or mode selections made by the operator (e.g., via speed selector 114).

As shown in FIG. 2, the speed controller 112 may be operably coupled to a first blade motor 120 and a second blade motor 122. The first blade motor 120 may power or turn a first blade 130, and the second blade motor 122 may power or turn a second blade 132. Although not shown, a third blade motor and corresponding third blade may also be included in some embodiments. Moreover, fourth and additional motors and blades could also be provided in alternative embodiments. Each of the first and second blade motors 120 and 122 (along with any others that may be included) may be powered by a power supply 140. In a typical case, the power supply 140 may be a single battery or battery pack. However, in other embodiments, each blade motor may have its own power supply.

Each of the first and second blades 130 and 132 (along with any other blades that may be included) may have a corresponding speed sensor associated therewith. Thus, the first blade 130 may have a first speed sensor 150 associated therewith, and the second blade 132 may have a second speed sensor 152 associated therewith. The first and second speed sensors 150 and 152 may be configured to determine the rotational speed (e.g., RPM) of the corresponding blade (e.g., the first and second blades 130 and 132, respectively) with which each is associated. The first and second speed sensors 150 and 152 may use optical, vibrational, electrical, or any other suitable sending means in order to determine blade speed.

In an example embodiment, the first and second speed sensors 150 and 152 may be embodied as an electronic, magnetic or Hall effect sensor. In such an example, the sensor may be placed proximate to a moving portion of the blade, shaft, or other component that may correspondingly have a magnet or other electric field generator thereon. Thus, when the magnet or field moves past the sensor, a reading may be passively obtained that may be indicative of RPM.

In an example embodiment, the speed controller 112 may determine a target speed (as described in greater detail below) for each of the first and second blades 130 and 132. The first and second speed sensors 150 and 152 may measure current blade speed for the first and second blades 130 and 132, respectively, and provide such measurements to the speed controller 112. The speed controller 112 may determine if the current blade speed does not match the target speed for any one of the blades and control the corresponding blade motor to get the current blade speed adjusted to match the target speed.

More particularly, as noted above, rather than running both the first and second blade motor 120 and 122 to achieve the same blade speeds for the first and second blades 130 and 132, the speed controller 112 of an example embodiment may operate the first and second blade motor 120 and 122 to achieve different blade speeds for the first and second blades 130 and 132. The difference may be due to the fact that for most multi-blade cutting decks, the blades do not necessarily have equal impact on the airflow generation in the cutting deck. For example, a blade that is closest to the discharge or outlet will typically be most impactful on airflow or update.

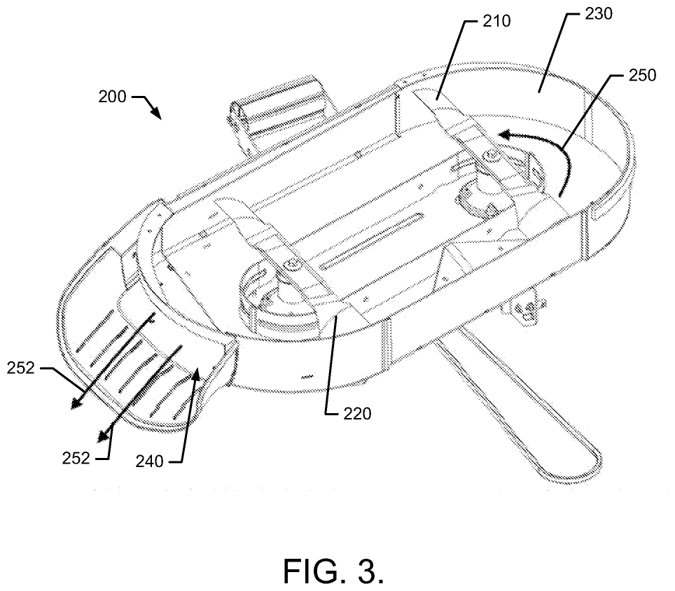

FIG. 3 illustrates a cutting deck 200 that has two blades (i.e., first blade 210 and second blade 220) within the same cutting deck body 230 or shroud. The cutting deck body 230 of this example has a side discharge chute 240. The first and second blades 210 and 220 may each rotate in the same direction (which in this example is shown by arrow 250) to generate airflow that causes ejection of grass clippings from the side discharge chute 240 as shown by arrows 252. In this example, the second blade 220 is closest to the side discharge chute 240. Thus, the second blade 220 may be more impactful on airflow generation for discharge. Given that the second blade 220 is more impactful on airflow generation for the cutting deck 200, it may be possible to achieve maximum efficiency by reducing the speed of the first blade 210 relative to the second blade 220. Thus, for example, the speed controller 112 may be configured to operate the second blade 220 at a higher speed than the first blade 210.

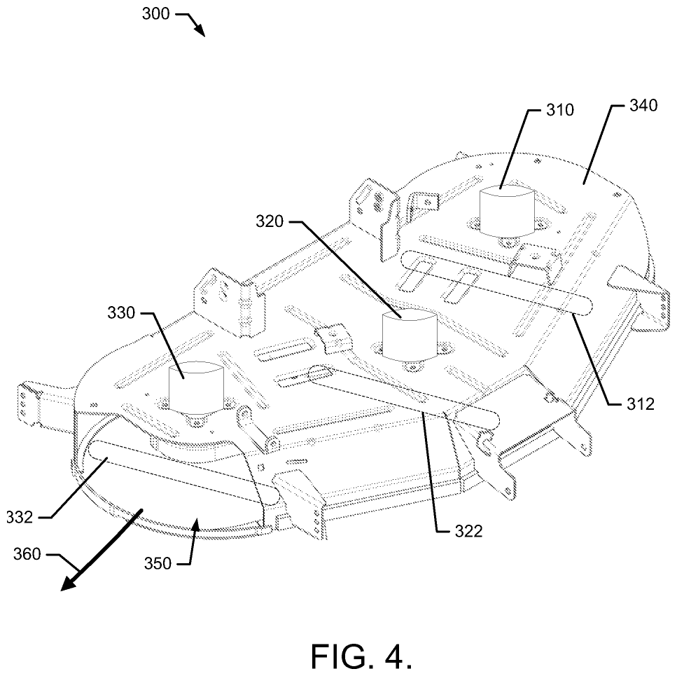

FIG. 4 illustrates a cutting deck 300 that has three blade motors (i.e., first blade motor 310, second blade motor 320, and third blade motor 330) within the same cutting deck body 340 or shroud. Each motor powers its own blade including a first blade 312, second blade 322 and third blade 332, respectively. The first, second and third blades 312, 322 and 332 are shown in dashed lines to indicate where such blades may be located within the cutting deck body 340 since they may not be visible given the orientation of the cutting deck 340. The cutting deck 300 of this example also has a side discharge chute 350. The first, second and third blades 312, 322 and 332 may each rotate in the same direction to generate airflow that causes ejection of grass clippings from the side discharge chute 350 as shown by arrow 360. In this example, the third blade 332 is closest to the side discharge chute 350. Thus, the third blade 332 may be more impactful on airflow generation for discharge. Given that the third blade 332 is more impactful on airflow generation for the cutting deck 300, it may be possible to achieve maximum efficiency by reducing the speed of the first blade 312 and second blade 322 relative to the third blade 332. Thus, for example, the speed controller 112 may be configured to operate the third blade 332 at a higher speed than the first blade 312 and second blade 322. Although examples including two and three blades are specifically shown in FIGS. 3 and 4, it should be appreciated that example embodiments may also extend to inclusion of any other number of blades.

In an example embodiment, analysis of a 48 inch three bladed deck having a configuration similar to that of FIG. 4 achieved a maximum collection rate at a blade speed (for each blade) of 4200 RPM. This blade speed configuration resulted in 860 cubic feet per minute (CFM) rate of collection and required 1572 W of power. Meanwhile, by adjusting blade speeds to enable differential speeds therebetween, increased energy efficiency may be achieved. For example, by lowering the speed of the first and second blades 312 and 322 to a speed of 3000 RPM, while maintaining the third blade 332 (i.e., the one closest to the discharge chute 350) at 4200 RPM a reduction in power required to 958 W was achieved while collection rate reduced to only 759 CFM. Thus, a reduction to 88% of the maximum collection rate was achieved at 61% of the power consumption. Accordingly, it can be appreciated that various combinations of speeds may be employed to alter power consumption more dramatically than the corresponding change to airflow generation when blades are run at different speeds instead of at the same speed. This can lead to longer run times with performance that is very nearly at a maximum performance level.

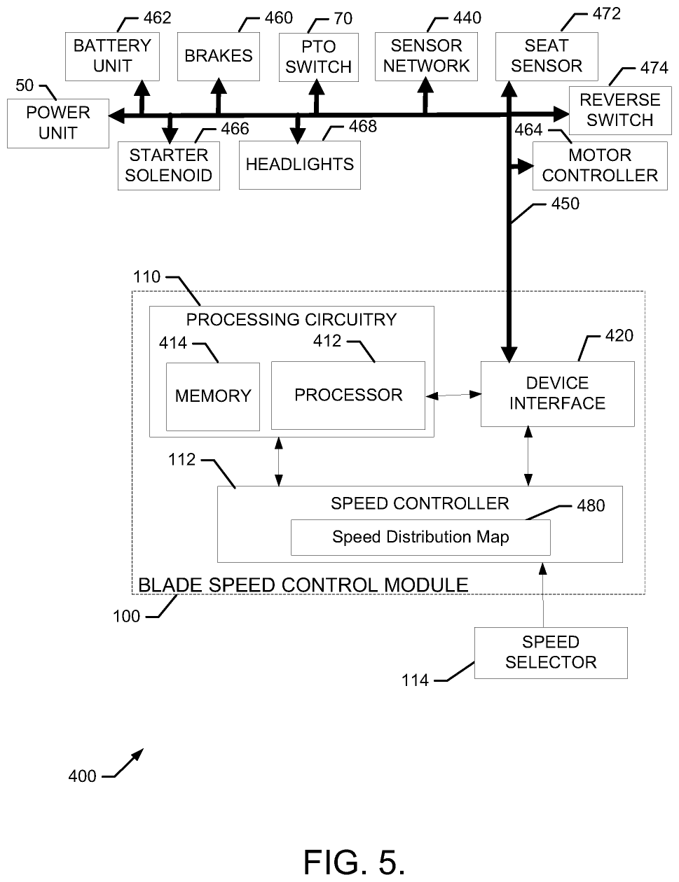

FIG. 5 illustrates a functional block diagram for explaining the operation of a vehicle or blade speed control system 400 incorporating the blade speed control module 100 of an example embodiment. As shown in FIG. 5, the blade speed control module 100 may include processing circuitry 110 to control operation of the power unit 50 of the riding lawn care vehicle 10 of an example embodiment as described herein. In this regard, for example, the blade speed control module 100 may utilize the processing circuitry 110 to provide electronic control inputs to one or more functional units of the riding lawn care vehicle 10 and to process data generated by the one or more functional units regarding various operational parameters relating to the riding lawn care vehicle 10. The processing circuitry 110 may be configured to perform data processing, control function execution, and/or other processing and management services according to an example embodiment of the present invention. In some embodiments, the processing circuitry 110 may be embodied as a chip or chip set. In other words, the processing circuitry 110 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The processing circuitry 110 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 110 may include one or more instances of a processor 412 and memory 414 that may be in communication with or otherwise control a device interface 420 and, in some cases, a user interface. As such, the processing circuitry 110 may be embodied as a circuit chip (e.g., an integrated circuit chip) configured (e.g., with hardware, software, or a combination of hardware and software) to perform operations described herein. However, in some embodiments, the processing circuitry 110 may be embodied as a portion of an on-board computer. In some embodiments, the processing circuitry 110 may communicate with electronic components and/or sensors of a sensor network 440 (e.g., sensors that measure variable values related to riding lawn care vehicle parameters) of the riding lawn care vehicle 10 via a single data bus or multiple data buses (e.g., data bus 450), which may form a portion of the device interface 420 or which may connect to the device interface 420. As such, the data bus 450 may connect to a plurality or all of the sensors, switching components, and/or other electrically-controlled components of the riding lawn care vehicle 10 to the processing circuitry 110.

The device interface 420 may include one or more interface mechanisms for enabling communication with other devices (e.g., sensors of the sensor network 440 and/or other accessories or functional units such as motors, servos, switches, or other operational control devices for providing control functions). In some cases, the device interface 420 may be any means such as a device or circuitry embodied in either hardware, or a combination of hardware and software that is configured to receive and/or transmit data from/to sensors in communication with the processing circuitry 110, e.g., via the data bus 450. Thus, for example, the device interface 420 may provide interfaces for communication of components of the riding lawn care vehicle 10 via the data bus 450.

In an example embodiment, the data bus 450 may further provide a mechanism by which the processing circuitry 110 can interface with or control other functional units of the riding lawn care vehicle 10. For example, in some embodiments, the data bus 450 may provide control inputs to and/or receive status inputs from functional units such as any or all of the power unit 50, PTO switch or blade actuation switch 70, brakes 460 (which may include a parking brake), a battery unit 462, one or more motor controllers 464, a starter solenoid 466, headlights 468, seat sensor 472, reverse switch 474, and/or the like.

The user interface, if included, may be in communication with the processing circuitry 110 to receive an indication of a user input at the user interface and/or to provide an audible, visual, mechanical, or other output to the user. As such, the user interface may include, for example, a display, one or more levers, switches, buttons or keys (e.g., function buttons), and/or other input/output mechanisms. In an example embodiment, the user interface may include the speed selector 114, which may indicate a plurality of different selectable modes, functions or speeds that the user can select. Each different mode, function or speed selection may have a corresponding speed distribution strategy associated therewith. In an example embodiment, the speed distribution strategy may be implemented via a speed distribution map 480 or lookup table. For example, the speed distribution map 480 may define a corresponding target blade speed for each individual blade in the cutting deck. As noted above, the target blade speed for the blade closest to the outlet of the cutting deck may be higher than the target blade speed of any other blades in selections aimed at increasing efficiency. However, blades speeds may be the same, and/or maximized, selections that are not aimed at improving or maximizing efficiency.

In an example embodiment, the speed distribution map 480 may therefore include both some settings or selections that match blade speeds for all blades, and some that define a mismatch in blade speed for at least some of the blades. For example, a maximum performance setting may be the least efficient setting, since it may define maximum and equal speeds as the target blade speed for each blade. Meanwhile, a maximum efficiency setting may define a higher speed for the blade nearest the outlet of the cutting deck, and lowest (or lower) speeds for all other blades. Other settings, associated with various other levels of performance, and in some cases associated with specific functions (e.g., mulching, side discharging, rear discharging, collecting, etc.) may alternatively be defined in the speed distribution map 480 and selectable via the speed selector 114.

The control system 400 may further include or be operably coupled to an instance of the blade speed control module 100 of an example embodiment. The blade speed control module 100 may be any means or device configured to perform the corresponding functionality of the blade speed control module 100 as described herein. In some cases, the blade speed control module 100 may include circuitry embodied in either hardware, or a combination of hardware and software that is configured to receive data provided from specific components, sensors or the like, from which blade speed data can be extracted in order to determine current blade speed for provision to or use within the control system 400. The blade speed control module 100 and/or the control system 100 may then utilize the current blade speed data obtained to compare to the target blade speed determined by the blade speed control module 100 to control blade speed to match selections made by the speed selector 114 or settings defined by the speed distribution map 480 as described herein.

Accordingly, some example embodiments may include a blade speed control module for outdoor power equipment having at least a first cutting blade and a second cutting blade. The may blade speed control module may include processing circuitry that may be configured to receive an operational setting defining a first target blade speed for the first cutting blade and a second target blade speed for the second cutting blade, where the first and second cutting blade speeds are different. The processing circuitry may be further configured to receive blade speed data indicating a first current blade speed for the first cutting blade and a second current blade speed for the second cutting blade, and control blade speeds for each of the first and second cutting blades to cause the first and second current blade speeds to substantially match the first and second target blade speeds, respectively.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the first and second target blade speeds may be defined in a blade speed map stored in memory of the processing circuitry. In an example embodiment, the module further includes a speed selector that defines a plurality of selectable modes or functions, each having corresponding operational settings for the first and second target blade speeds. In some cases, the selectable modes or functions may include at least one other operational setting in which the first and second target blade speeds are the same. In an example embodiment, the selectable modes or functions may include a mulch setting, a collection setting, and a discharge setting. In some cases, the blade speed map may define a highest blade speed for the first cutting blade responsive to the first cutting blade being positioned closest to an outlet of a cutting deck of the outdoor power equipment. In an example embodiment, the outdoor power equipment may further include a third cutting blade and the processing circuitry may be further configured to receive an operational setting defining a third target blade speed for the third cutting blade, receive blade speed data indicating a third current blade speed for the third cutting blade, and control blade speed the third cutting blade to cause the third current blade speed to substantially match the third target blade speed. In some cases, the third target blade speed may be the same as the second target blade speed and different from the first target blade speed. In an example embodiment, the outdoor power equipment may be either a riding lawn mower or a walk behind lawn mower.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

That which is claimed:

1. A blade speed control module (100) for outdoor power equipment (10) having at least a first cutting blade (130) and a second cutting blade (132), the module (100) comprising processing circuitry (110) configured to:
receive an operational setting defining a first target blade speed for the first cutting blade (130) and a second target blade speed for the second cutting blade (132), the first and second cutting blade speeds being different;
receive blade speed data indicating a first current blade speed for the first cutting blade (130) and a second current blade speed for the second cutting blade (132); and
control blade speeds for each of the first and second cutting blades (130 and 132) to cause the first and second current blade speeds to substantially match the first and second target blade speeds, respectively.

2. The module (100) of claim 1, wherein the first and second target blade speeds are defined in a blade speed map (480) stored in memory (414) of the processing circuitry (110).

3. The module (100) of claim 2, further comprising a speed selector (114), wherein the speed selector (114) defines a plurality of selectable modes or functions, each having corresponding operational settings for the first and second target blade speeds.

4. The module (100) of claim 3, wherein the selectable modes or functions include at least one other operational setting in which the first and second target blade speeds are the same.

5. The module (100) of claim 3, wherein the selectable modes or functions include a mulch setting, a collection setting, and a discharge setting.

6. The module (100) of claim 2, wherein the blade speed map (480) defines a highest blade speed for the first cutting blade (130) responsive to the first cutting blade (130) being positioned closest to an outlet (240) of a cutting deck (40) of the outdoor power equipment (10).

7. The module (100) of claim 1, wherein the outdoor power equipment (10) further includes a third cutting blade (332), and wherein the processing circuitry (110) is further configured to:
receive an operational setting defining a third target blade speed for the third cutting blade (332);
receive blade speed data indicating a third current blade speed for the third cutting blade (332); and
control blade speed for the third cutting blade (332) to cause the third current blade speed to substantially match the third target blade speed.

8. The module (100) of claim 7, wherein the third target blade speed is the same as the second target blade speed and different from the first target blade speed.

9. The module (100) of claim 1, wherein the outdoor power equipment (10) is a riding lawn mower.

10. The module (100) of claim 1, wherein the outdoor power equipment (10) is a walk behind lawn mower.

11. A lawn care device (10) comprising:
a power unit (50) to selectively power the device (10);
a first cutting blade (130);
a second cutting blade (132); and
a blade speed control module (100) comprising processing circuitry (110) configured to:
receive an operational setting defining a first target blade speed for the first cutting blade (130) and a second target blade speed for the second cutting blade (132), the first and second cutting blade speeds being different;
receive blade speed data indicating a first current blade speed for the first cutting blade (130) and a second current blade speed for the second cutting blade (132); and
control blade speeds for each of the first and second cutting blades (130 and 132) to cause the first and second current blade speeds to substantially match the first and second target blade speeds, respectively.

12. The device (10) of claim 11, wherein the first and second target blade speeds are defined in a blade speed map (480) stored in memory (414) of the processing circuitry (110).

13. The device (10) of claim 12, further comprising a speed selector (114), wherein the speed selector (114) defines a plurality of selectable modes or functions, each having corresponding operational settings for the first and second target blade speeds.

14. The device (10) of claim 13, wherein the selectable modes or functions include at least one other operational setting in which the first and second target blade speeds are the same.

15. The device (10) of claim 13, wherein the selectable modes or functions include a mulch setting, a collection setting, and a discharge setting.

16. The device (10) of claim 12, wherein the blade speed map (480) defines a highest blade speed for the first cutting blade (130) responsive to the first cutting blade (130) being positioned closest to an outlet (240) of a cutting deck (40) of the device (10).

17. The device (10) of claim 11, wherein the device (10) further includes a third cutting blade (332), and wherein the processing circuitry (110) is further configured to:
receive an operational setting defining a third target blade speed for the third cutting blade (332);
receive blade speed data indicating a third current blade speed for the third cutting blade (332); and
control blade speed for the third cutting blade (332) to cause the third current blade speed substantially match the third target blade speed.

18. The device (10) of claim 17, wherein the third target blade speed is the same as the second target blade speed and different from the first target blade speed.

19. The device (10) of claim 11, wherein the device (10) is a riding lawn mower.

20. The device (10) of claim 11, wherein the device (10) is a walk behind lawn mower.
